(19) United States
(12) Patent Application Publication
(10) Pub. No.: US 2019/0225164 A1
(43) Pub. Date: Jul. 25, 2019

(54) Steering Wheel Storage Device

(71) Applicant: Nena Ahmad-Elbey, Charlotte, NC (US)

(72) Inventor: Nena Ahmad-Elbey, Charlotte, NC (US)

(21) Appl. No.: 16/256,671

(22) Filed: Jan. 24, 2019

Related U.S. Application Data
(60) Provisional application No. 62/621,313, filed on Jan. 24, 2018.

(51) Int. Cl. B60R 11/02

(52) U.S. Cl. CPC B60R 11/0241; B60R 2011/001

(57) ABSTRACT

A steering wheel storage device. The steering wheel storage device has a base. The base attaches to the steering wheel column of an automobile via a fastener. A housing is attached to the base via a fastener and is designed to store vehicle documents. The housing has an interior cavity that is accessed through an opening. At least one pocket is integrated in the front face of the housing.

### CROSS REFERENCE TO RELATED APPLICATIONS

This application claims the benefit of U.S. Provisional Application No. 62/621,313 filed on Jan. 24, 2018. The above identified patent application is herein incorporated by reference in its entirety to provide continuity of disclosure.

### BACKGROUND OF THE INVENTION

The present invention relates to a steering wheel storage device. More specifically, the present invention provides a storage device configured to be secured to the steering wheel of an automobile such that items, such as personal identification cards and vehicle registration information can be stored therein.

Under most state laws, individuals who are subjected to traffic stops may be required by a law enforcement officer to retrieve information. Specifically, a driver's license, vehicle registration certificate and proof of insurance may be requested. Typically, a driver may store this information in a glove compartment, in a vehicle console or in a purse or a wallet. However, during a traffic stop, accessing these areas may be difficult as the items may be difficult to find amidst clutter. Furthermore, if a driver is nervous, additional anxiety may result from taking a long time to locate the requested items.

Because of the lack of ease of access associated with storing vehicle information in vehicle compartments and purses or wallets, and the inconvenience associated with needing to produce this information, there is a need in the known art for a device that allows for a driver to more easily and efficiently access any requested documents from the driver seat of an automobile.

### SUMMARY OF THE INVENTION

In view of the foregoing disadvantages inherent in the known types of integrated automobile storage devices now present in the known art, the present invention provides a steering wheel storage device wherein the same can be utilized for providing convenience for the user when storing important vehicle documents in his or her automobile.

The present system comprises a base having a first side disposed oppositely a second side. An adhesive is disposed on the base. The base has a fastener on an external surface thereof. The fastener is configured to affix a housing to the base. The housing has a front face and a rear face. The rear face is configured to correspond to the fastener. Furthermore, the housing has an open end that provides access to an interior cavity. At least one pocket is disposed on the housing.

In another embodiment, the steering wheel storage device further comprises a padding disposed on the housing, such as to provide protection for a user in the event of contact with the steering wheel storage device.

In a further embodiment, the steering wheel storage device comprises a transparent pocket, such that the contents of the transparent pocket will be viewable through the pocket itself.

In yet a further embodiment, the steering wheel storage device comprises an open end that is securable in a closed position, such that the contents of the internal cavity can be secured in the housing.

In another embodiment, the steering wheel storage device comprises at least one pocket that is freely removable from the housing, such that the steering wheel storage device can be customized for various needs of the user.

In a further embodiment, the steering wheel storage device comprises an open end disposed on an upper edge of the housing, such that the open end is accessible from an upper portion of the housing.

In yet another embodiment, the steering wheel storage device comprises an open end disposed on a side edge of the housing, such that the open end is accessible from a side portion of the housing.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the steering wheel storage device.

FIG. 2 shows a perspective view of an embodiment of the steering wheel storage device in use.

FIG. 3 shows a perspective view of an embodiment of the steering wheel storage device in use.

### DETAILED DESCRIPTION OF THE INVENTION

Reference is made herein to the attached drawings. Like reference numerals are used throughout the drawings to depict like or similar elements of the steering wheel storage device. The figures are intended for representative purposes only and should not be considered to be limiting in any respect.

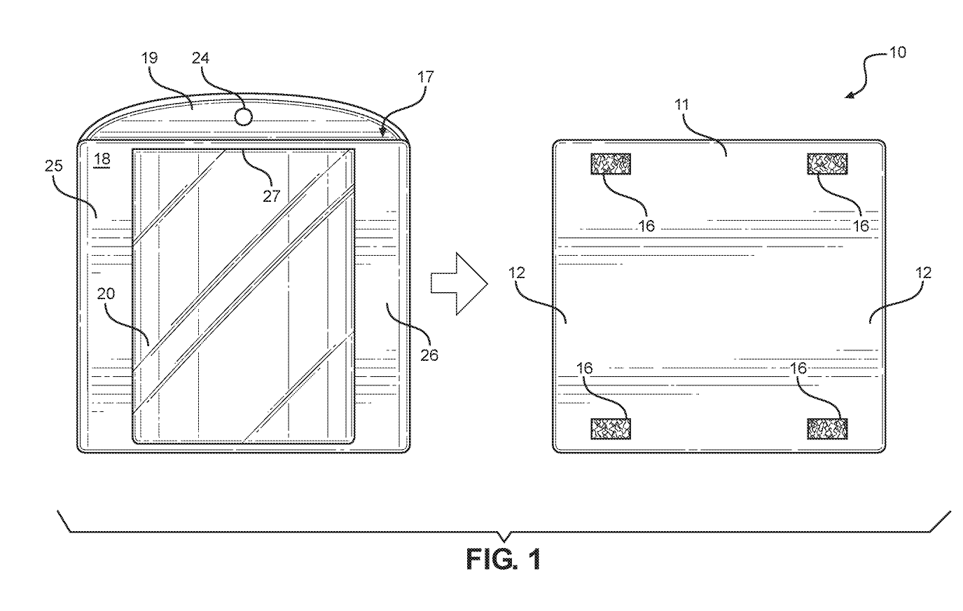

Referring now to FIG. 1, there is shown an exploded view of an embodiment of the steering wheel storage device. The steering wheel storage device 10 comprises a base 11. The base 11 is configured to secure to a steering wheel column of an automobile, such that a plurality of contents of the steering wheel storage device 10 will be accessible from the driver seat of the automobile. In one embodiment, the base 11 is made of a flexible material, such that it will conform to the shape of the steering wheel upon which it is secured. The base 11 has a first side 12 disposed oppositely a second side 13. An adhesive 14 is configured to secure the base to a targeted location, such as to a column of a steering wheel of an automobile.

The base 11 includes at least one fastener 16 thereon. The fastener 16 is configured to secure a housing 17 to the base. In the illustrated embodiment, the fastener 16 is a hook and loop fastener, wherein one of a hook portion and a loop portion of the hook and look fastener is disposed on a top surface of the base 11 while a corresponding portion is disposed on a rear surface of the housing 17. In the illustrated embodiment, a plurality of fasteners 16 is disposed around a top surface perimeter of the base 11, such as to corresponding to a plurality of fasteners 16 disposed on a rear surface perimeter of the housing 17. Furthermore, as shown, where the base is quadrilateral in shape, a fastener of the plurality of fasteners 16 is disposed proximal to each corner.

The housing 17 comprises a front face 18. The front face 18 is disposed oppositely the rear surface of the housing 17. The front face 18 is configured to be viewable and accessible from the driver seat of an automobile. For example, the front face 18 is viewable and accessible from the driver seat of an automobile such that driver information may be accessible to a driver while operating the automobile.

Furthermore, the housing 17 comprises an open end 19. The open end 19 is configured to provide access to an interior cavity. The interior cavity is configured to receive a plurality of contents therein. In the illustrated embodiment, the open end 19 is disposed on an upper edge of the housing 17. In an alternate embodiment, the open end 19 is disposed on either of a first side edge 25 or a second side edge 26 of the housing 17. In one embodiment, the open end 19 is securable in a closed position, such as by the action of a closing fastener 24.

At least one pocket 20 is disposed on the front face 18 of the housing 17. The pocket 20 comprises an opening 27 such that at least one object can be placed in the pocket 20. In the illustrated embodiment, the steering wheel storage device 10 comprises a singular pocket 20 on the front face 18 of the housing 17. The pocket 20 is dimensioned to be of a smaller perimeter than the housing 17 itself. In one embodiment, at least one pocket 20 is freely removable from the front face 18 of the housing.

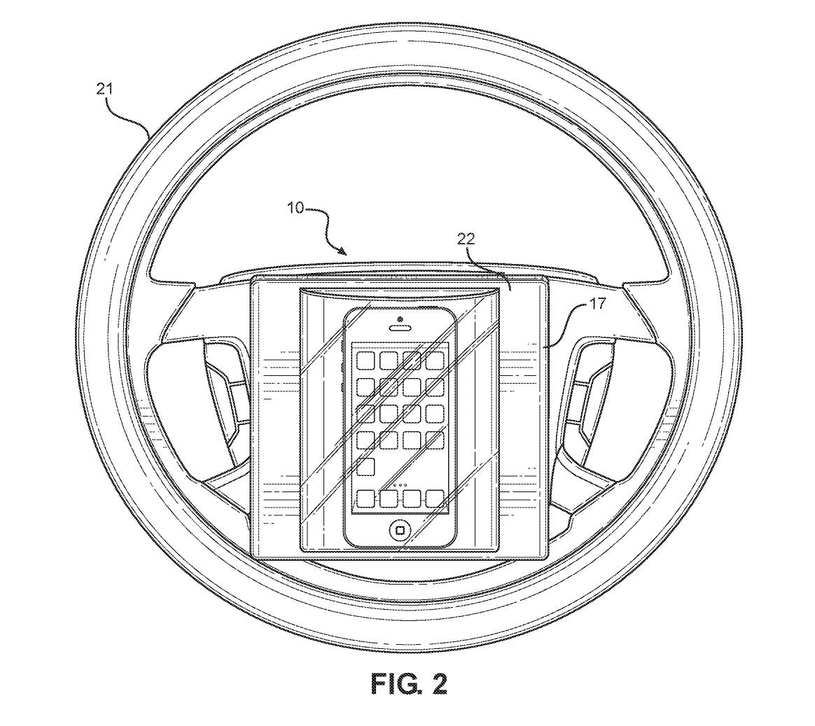

Referring now to FIG. 2, there is shown a perspective view of an embodiment of the steering wheel storage device. In the illustrated embodiment, the steering wheel storage device 10 is secured to a steering wheel 21. In the illustrated embodiment, the steering wheel storage device 10 further comprises a padded material 22 on the front face of the housing 17. The padded material 22 provides convenience to a user where the user may desire to rest a head or an arm upon the steering wheel storage device 10.

Additionally, in the illustrated embodiment, the steering wheel storage device 10 further comprises a pocket 20 on the front face that is transparent. When the pocket 20 is transparent, the contents of the pocket 20 are accessible to the operator of the automobile. In the illustrated embodiment, the pocket 20 is transparent because the pocket 20 is made of a clear plastic material. In the illustrated embodiment, a mobile device is disposed in the pocket 20. Due to the transparency of the pocket 20, the mobile phone is viewable through the pocket 20.

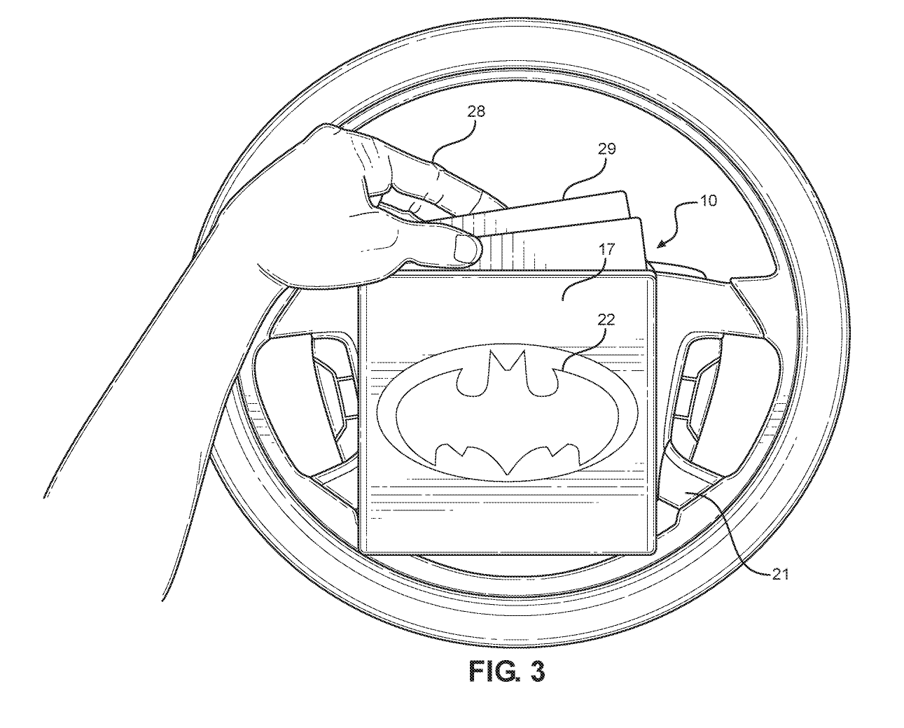

Referring now to FIG. 3, there is shown a perspective view of an alternate embodiment of the steering wheel storage device. In use, the steering wheel storage device 10 is mounted upon a steering wheel 21 of an automobile via an adhesive. The steering wheel storage device 10 is accessible by the driver 28 from the driver seat of the automobile. In the illustrated embodiment, vehicle information documents, in the form of paper documents, 29 are accessible from the interior cavity of the housing 17 through the open end 19. In the illustrated embodiment, the padded material 22 is centrally disposed on the front face of the housing 17.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A steering wheel storage device, comprising:
a base having a first side disposed oppositely a second side;
an adhesive configured to secure the base to a targeted surface;
the base having at least one fastener thereon;
the fastener configured to affix to a housing;
the housing having a front face and an open end;
the open end providing access to an interior cavity;
at least one pocket disposed on the front face of the housing.

2) The steering wheel storage device of claim 1, further comprising a padded material disposed on the front face of the housing.

3) The steering wheel storage device of claim 1, wherein the pocket is transparent.

4) The steering wheel storage device of claim 1, wherein the open end is securable in a closed position.

5) The steering wheel storage device of claim 1, wherein the at least one pocket is freely removable form the housing.

6) The steering wheel storage device of claim 1, wherein the open end is disposed on an upper edge of the housing.

7) The steering wheel storage device of claim 1, wherein the open end is disposed on a side edge of the housing.
